(19) United States
(12) Patent Application Publication
(10) Pub. No.: US 2003/0025056 A1
(43) Pub. Date: Feb. 6, 2003

(54) Magnetic tool and part holder

(76) Inventors: Linda C. Atchley, Louisville, TN (US); Kenneth H. Samples, Charleston, WV (US)

Correspondence Address: Larry W. McKenzie, Walker, McKenzie & Walker, P.C., Suite 434, 6363 Poplar Avenue, Memphis, TN, 38119-4896, US

(21) Appl. No.: 10/161,542

(22) Filed: Jun. 3, 2002

Related U.S. Application Data
(63) Continuation-in-part of application No. 29/126,704, filed on Jul. 24, 2000, now Pat. No. D461640.

(51) Int. Cl. F16B 45/00

(52) U.S. Cl. 248/304; 248/339

(57) ABSTRACT

A tool and part holder for holding various tools and miscellaneous parts. The holder includes an elongated bar having a first end, a second end, a hook at the first end thereof, a magnetic portion at the second end thereof, and a non-magnetic portion at the first end thereof.

### CROSS REFERENCE TO RELATED APPLICATIONS

This application is a continuation-in-part of pending U.S. patent application Ser. No. 29/126,704, filed Jul. 24, 2000, entitled “TOOL AND PART HOLDER.”

### BACKGROUND OF THE INVENTION

1. Field of the Invention: The present invention relates to products for holding various items (tools, miscellaneous small parts, etc.) in a convenient, safe, organized manner.

2. Information Disclosure Statement: A preliminary patentability search in class 211, subclass 309.4; class 206, subclass 818; and class 211, subclass 70.6, produced the following patents, which may be relevant to the present invention: Winton, U.S. Pat. No. 361,248, issued Apr. 12, 1887; Brown et al., U.S. Pat. No. 3,204,776, issued Dec. 23, 1963; Muirhead, U.S. Pat. No. 4,405,108, issued Sep. 20, 1983; Bosch et al., U.S. Pat. No. 4,826,059, issued May 2, 1989; Birnbaum, U.S. Pat. No. 5,274,1994, issued Jan. 4, 1994; Coleman et al., U.S. Pat. No. 5,301,822, issued Apr. 12, 1994; Singleton, U.S. Pat. No. 5,560,480, issued Oct. 1, 1996; Maznik, U.S. Pat. No. 5,630,517, issued May 20, 1997; Winnard, U.S. Pat. No. 5,660,276, issued Aug. 26, 1997; and Testa et al., U.S. Pat. No. 5,760,668, issued Jun. 2, 1998.

Winton, U.S. Pat. No. 361,248, discloses a holder for metal articles that consist of one or more magnets and a suspending or enclosing frame firmly attached to the magnets.

Brown et al., U.S. Pat. No. 3,204,776, discloses a magnetic tool board comprising a board having a front panel with at least one shelf thereon, at least one magnet carried by the board above the shelf, the shelf and magnet being vertically movable on the board relative to one another.

Muirhead, U.S. Pat. No. 4,4405,108, discloses a device for retaining a metal tool such as a socket, the device comprising a holder, a mounting post projecting outward from the holder, and a magnet having a hole for receiving the mounting post.

Bosch et al., U.S. Pat. No. 4,826,059, discloses a foldable magnet tool holder comprising a generally rectangular main body of flexible material having at least two interior magnet holding portions, and a set of magnetic bars disposed in each interior magnet holding portion.

Birnbaum, U.S. Pat. No. 5,274,937, discloses a flexible holder having a pocket open on its top and one side, and a flexible magnetized sheet for being placed within the pocket.

Coleman, U.S. Pat. No. 5,301,822, discloses a magnetic tool holder comprising a body member having a longitudinal channel; a receiving magnet disposed in the longitudinal channel; and detent means provided on the receiving magnet and the longitudinal channel to hold the receiving magnet in the longitudinal channel.

Singleton, U.S. Pat. No. 5,560,480, discloses a socket holder apparatus that can be magnetically attached to any metal surface while firmly securing a set of wrench sockets therein. The socket holder has individual sleeves, each capable of receiving a socket, and a radial contracting member secured to each sleeve for gripping the socket as it is placed within the sleeve.

Maznik, U.S. Pat. No. 5,630,517, discloses a hair styling tools and appliances holding apparatus comprising a base, means for securing the base to a support surface, an arm connected to the base and having magnetic means for releasably securing the tools and appliances, and a bracket connected to the arm for holding at least one tool or appliance.

Winnard, U.S. Pat. No. 5,660,276, discloses a magnetic tool organizer comprising a top body member having a plurality of spaced apart apertures; a bottom body member; and a magnetic segment between the top and bottom body members, the magnetic segment having a plurality of spaced apart apertures complimentary to at least part of the apertures of the top body member.

Testa et al., U.S. Pat. No. 5,760,668, discloses a magnetic tool and object holding apparatus comprising a metallic casing having a box-like configuration with an enclosed back surface panel; and a plurality of bar magnets within the casing with one half of the bar magnets having their north pole faces attached to the back surface panel of the casing and with the remainder of the bar magnets having their south pole faces attached to the back surface panel of the casing.

None of these references, either singly or in combination, disclose or suggest the present invention. More specifically, nothing in the known prior art discloses or suggest a tool and part holder including an elongated bar having a first end, a second end, a hook at the first end thereof, a magnetic portion at the second end thereof, and a non-magnetic portion at the first end thereof.

### BRIEF SUMMARY OF THE INVENTION

The present invention provides a magnetized tool and part holder for holding loose tools and small parts such as bolts, nuts, washers, etc. The concept of the present invention is to provide a device that acts as an extra hand to allow workers and hobbyist to organize and secure tools and miscellaneous small parts at “a finger's reach.”

The tool and part holder of the present invention includes an elongated bar having a first end, a second end, a hook at the first end thereof, a magnetic portion at the second end thereof, and a non-magnetic portion at the first end thereof.

One object of the present invention is to provide a new tool and part holder that is very useful to professionals in various businesses and to non-professionals for use at home and while traveling, etc.

Another object of the present invention is to provide anyone with an “extra” or “third” hand when needed to complete most any task, to save time and keep “bits and pieces” of small tools and parts organized and at “a finger's reach”—creating a safer environment for the user.

Another object of the present invention is to provide a tool and part holder that is extremely “user friendly” and that will meet a variety of needs in a variety of professions and industries. The holder of the present invention can be used in changing light bulbs (will hold the screws and light bulb); while installing pictures, ceiling fans, garage-door openers; in the aerospace industry; by building supply businesses; in plumbing (kept in a plumber's handy bag); for home appliance repair; in the transportation industry; in the communication industry (installing mobile phones, audio systems, etc.); for aircraft maintenance; for lawn and garden chores; in roofing; by electricians, builders, machinists, assembly-line personnel; for automobile maintenance (e.g., changing oil); and for any chore requiring small parts in difficult locations with no one to assist, etc.

### BRIEF DESCRIPTION OF THE SEVERAL VIEWS OF THE DRAWINGS

FIG. 1 is a front elevational view of a first embodiment of a bar of the tool and part holder of the present invention, the rear elevational view being substantially a mirror image thereof.

FIG. 2 is a right side elevational view of the bar of FIG. 1.

FIG. 3 is a left side elevation of the bar of FIG. 1.

FIG. 4 is a top plan view of the bar of FIG. 1.

FIG. 5 is a bottom plan view of the bar of FIG. 1.

FIG. 5A is a somewhat diagrammatic front elevational view of the proximal end of the bar of FIG. 1, shown being mounted on support structure.

FIG. 5B is a somewhat diagrammatic front elevational view of the bar of FIG. 1, shown mounted on support structure with various tools and miscellaneous parts attached thereto and with portions thereof broken away for clarity.

FIG. 6 is a front elevational view of a second embodiment of a bar of the tool and part holder of the present invention, the rear elevational view being substantially a mirror image thereof.

FIG. 7 is a right side elevational view of the bar of FIG. 6.

FIG. 8 is a left side elevation of the bar of FIG. 6.

FIG. 9 is a top plan view of the bar of FIG. 6.

FIG. 10 is a bottom plan view of the bar of FIG. 6.

FIG. 10A is a somewhat diagrammatic front elevational view of the bar of FIG. 6, shown mounted on support structure with various tools and miscellaneous parts attached thereto.

FIG. 11 is a front elevational view of a third embodiment of a bar of the tool and part holder of the present invention, the rear elevational view being substantially a mirror image thereof.

FIG. 12 is a right side elevational view of the bar of FIG. 11.

FIG. 13 is a left side elevation of the bar of FIG. 11.

FIG. 14 is a top plan view of the bar of FIG. 11.

FIG. 15 is a bottom plan view of the bar of FIG. 11.

FIG. 15A is a somewhat diagrammatic front elevational view of the bar of FIG. 11, shown mounted on support structure with various tools and miscellaneous parts attached thereto.

FIG. 16 is a front elevational view of a first embodiment of a sheath of the tool and part holder of the present invention.

FIG. 17 is a sectional view substantially as taken on line 17-17 of FIG. 16.

FIG. 18 is a front elevational view of the sheath of FIG. 16, shown mounted on the bar of FIG. 11.

FIG. 19 is a sectional view substantially as taken on line 19-19 of FIG. 18.

FIG. 20 is a front elevational view of a second embodiment of a sheath of the tool and part holder of the present invention.

FIG. 21 is a sectional view substantially as taken on line 21-21 of FIG. 10.

FIG. 22 is a front elevational view of the sheath of FIG. 20, shown mounted on the bar of FIG. 11.

FIG. 23 is a sectional view substantially as taken on line 23-23 of FIG. 22.

### DETAILED DESCRIPTION OF THE INVENTION

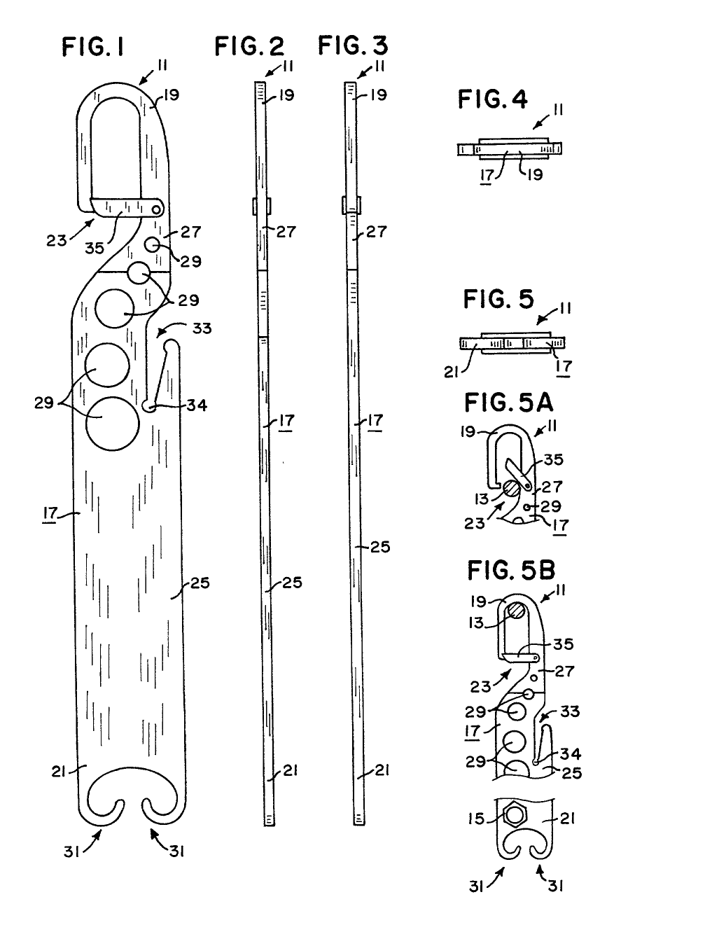

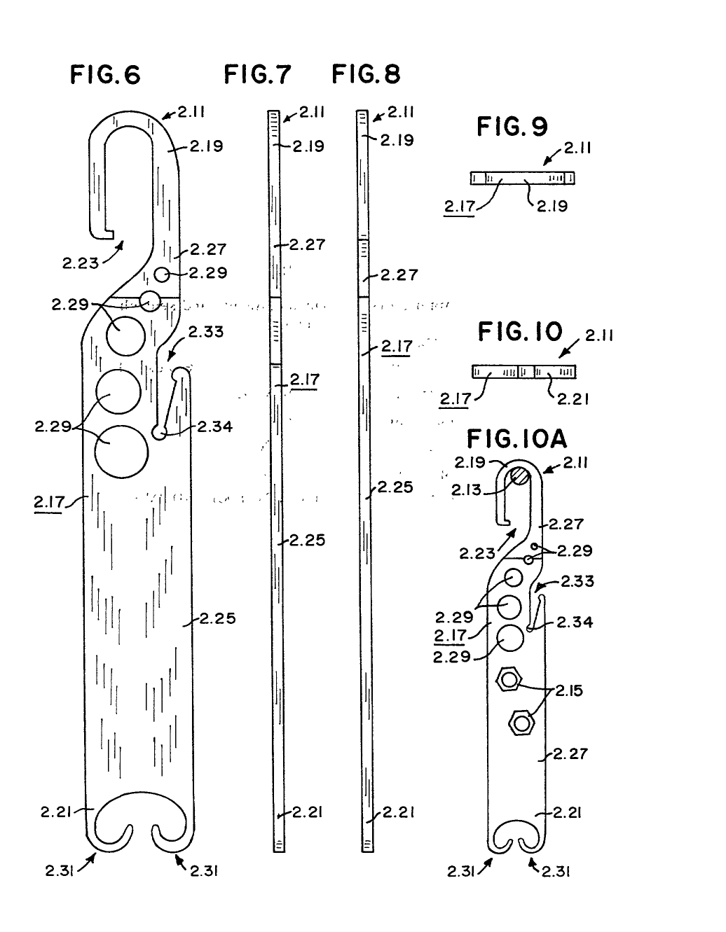

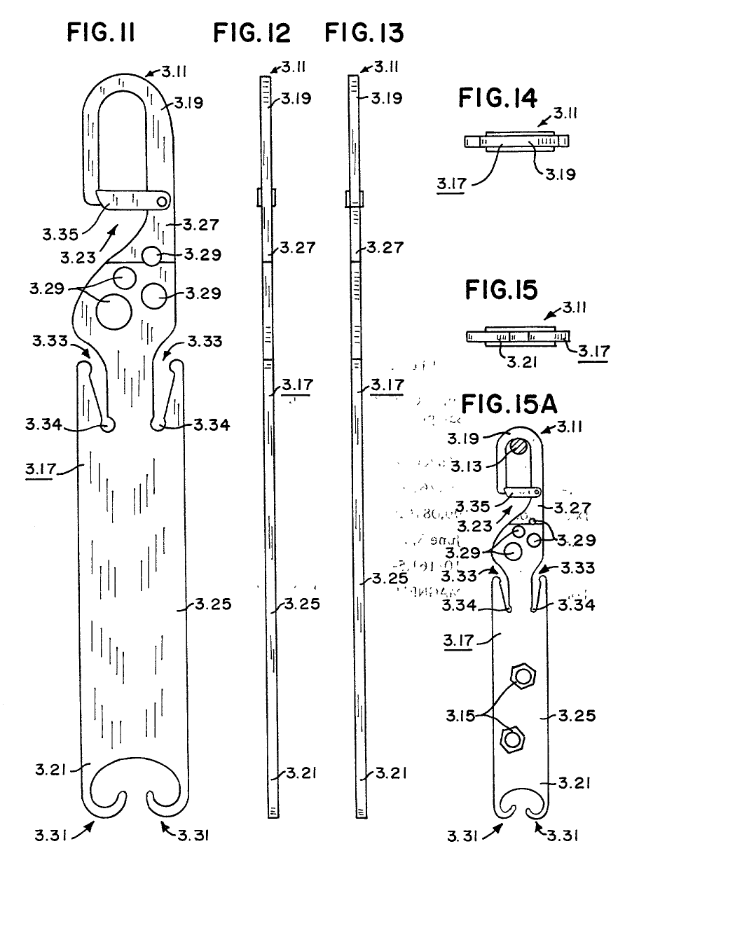

A first preferred embodiment of the tool and part holder of the present invention is shown in FIGS. 1-5B, and identified by the numeral 11. The holder 11 is especially designed to be hung from support structure 13 (see FIGS. 5A and 5B) such as, for example, part of the chassis of an automobile or the like being worked on, etc., and to hold various tools and miscellaneous parts 15 (see FIG. 5B) such as, for example, hammers, wrenches, screwdrivers, nuts, bolts, screws, nails, etc.

The holder 11 includes an elongated bar 17 having a first, or proximal, end 19 and Ad a second, or distal, end 21. The bar 17 has a top or main support hook 23 at the first end 19 thereof for preferably being hooked over the support structure 13 as shown in FIG. 5A. The bar 17 has a magnetic portion 25 at the second end 21 thereof for allowing certain tools and miscellaneous parts 15 to be attached thereto by magnetic force (e.g., tools and parts made at least partially of a ferrous metal or the like). The bar 17 has a non-magnetic portion 27 at the first end 19 thereof so that at least the first end 19 of the bar 17 can be supported from the support structure 13 without being magnetically attracted thereto. More than one half of the overall length of the bar 17 is preferably magnetic. More specifically, the ratio between the magnetic and non-magnetic portions 25, 27 is preferably 75 to 25, with 75% of the length of the bar 17 from the second end 21 preferably being magnetic and with 25% of the length of the bar 17 from the first end 19 preferably being non-magnetic.

The bar 17 preferably has a plurality of different sized apertures 29 extending therethrough for additional convenience in attaching non-magnetized objects to the holder 11. Thus, as clearly shown in FIG. 1, the bar 17 may have five apertures 29 extending therethrough ranging in size between, for example, 1 inch (2.54 centimeters), 9/16 inch (1.42875 centimeters), 1/2 inch (1.27 centimeters), 1/4 inch (0.635 centimeters), and 1/8 inch (0.3175 centimeters).

The bar 17 may have at least one and preferably two bottom hooks 31 at the second end 21 thereof for allowing non-magnetically attractable tools, small parts, etc., to be hung therefrom, or to allow the holder 11 to be hung from the support structure 13 from the second end 21 of the bar 17. When two hooks 31 are included, the hooks 31 preferably oppose one another (i.e., with the open or distal end of each hook 31 arranged toward the midline of the bar 17 as clearly shown in FIG. 1). The bar 17 may have a middle hook 33 between the first and second ends 19, 21 thereof for allowing non-magnetically attractable or antimagnetic tools, small parts, etc., to be hung therefrom. The bottom end of the hook 33 preferably forms an enlarged, keyhole portion 34.

The bar 17 may be constructed in various manners, out of various materials as will now be apparent to those skilled in the art. Thus, for example, the bar 17 may be cut or otherwise constructed as a one-piece, integral unit out of a metal capable of being permanently magnetized or the likes, or may be cut and welded out of a first bar of permanently magnetized metal to form the magnetic portion 25 and a second bar of nonmagnetic metal to form the non-magnetic portion 27, etc. The bar 17 may be constructed in various specific designs and sizes to fit a range of typical uses. For example, the bar 17 may be manufactured to have an overall length of 21 inches (53.34 centimeters), an overall width of 3 inches (7.62 centimeters), and a thickness of 0.25 inch (0.635 centimeters), with smooth, rounded edges, etc. The magnetic portion 25 of the bar 17 can be “permanently magnetized” in any manner now apparent to those skilled in the art such as, for example, by applying a magnetizing field from a stronger permanent magnet thereto, or by producing a magnetizing field by passing a large current through a coil.

The holder 11 may include a spring catch 35 for closing the hook 23 at the first end 19 of the bar 17. The spring catch 35 is preferably substantially similar to a typical carabiner-type catch used in mountain climbing and the like, with the catch 35 being urged to an open position by the support structure 13 when the hook 23 is being moved over the support structure 13 as shown in FIG. 5A, and with the catch 35 being urged back to a closed position by an internal spring or the like after the support structure 13 is moved into the bight portion of the hook 23 as clearly shown in FIG. 5B to thereby lock the bar 17 onto the support structure 13 until the user of the bar 17 manually moves the catch 35 back to the open position to allow the hook 23 to be moved off the support structure 13 as will now be apparent to those skilled in the art.

A second preferred embodiment of the tool and part holder of the present invention is shown in FIGS. 5-10A, and identified by the numeral 2.11. The holder 2.11 is especially designed to be hung from support structure 2.13 (see FIG. 10A) such as, for example, part of the chassis of an automobile or the like being worked on, etc., and to hold various tools and miscellaneous parts 2.15 (see FIG. 10A) such as, for example, hammers, wrenches, screwdrivers, nuts, bolts, screws, nails, etc.

The holder 2.11 is similar in basic construction to the holder 11, and includes an elongated bar 2.17 having a first, or proximal, end 2.19 and a second, or distal, end 2.21. The bar 2.17 has a top or main support hook 2.23 at the first end 2.19 thereof for preferably being hooked over the support structure 2.13 as shown in FIG. 10A. The bar 2.17 has a magnetic portion 2.25 at the second end 2.21 thereof for allowing certain tools and miscellaneous parts 2.15 to be attached thereto by magnetic force (e.g., tools and parts made at least partially of a ferrous metal or the like). The bar 2.17 has a non-magnetic portion 2.27 at the first end 2.19 thereof so that at least the first end 2.19 of the bar 2.17 can be supported from the support structure 2.13 without being magnetically attracted thereto. More than one half of the overall length of the bar 2.17 is preferably magnetic. More specifically, the ratio between the magnetic and non-magnetic portions 2.25, 2.27 is preferably 75 to 25, with 75% of the length of the bar 2.17 from the second end 2.21 preferably being magnetic and with 25% of the length of the bar 2.17 from the first end 2.19 preferably being non-magnetic.

The bar 2.17 preferably has a plurality of different sized apertures 2.29 extending therethrough for additional convenience in attaching non-magnetized objects to the holder 2.11. Thus, as clearly shown in FIG. 6, the bar 2.17 may have five apertures 2.29 extending therethrough ranging in size between, for example, 1 inch (2.54 centimeters), 9/16 inch (1.42875 centimeters), 1/2 inch (1.27 centimeters), 1/4 inch (0.635 centimeters), and 1/8 inch (0.3175 centimeters).

The bar 2.17 may have at least one and preferably two bottom hooks 2.31 at the second end 2.21 thereof for allowing non-magnetically attractable tools, small parts, etc., to be hung therefrom, or to allow the holder 2.11 to be hung from the support structure 2.13 from the second end 2.21 of the bar 2.17. When two hooks 2.31 are included, the hooks 2.31 preferably oppose one another (i.e., with the open or distal end of each hook 2.31 arranged toward the midline of the bar 2.17 as clearly shown in FIG. 6). The bar 2.17 may have a middle hook 2.33 between the first and second ends 2.19, 2.21 thereof for allowing non-magnetically attractable or antimagnetic tools, small parts, etc., to be hung therefrom. The bottom end of the hook 2.33 preferably forms an enlarged, keyhole portion 2.34.

The bar 2.17 may be constructed in various manners, out of various materials as will now be apparent to those skilled in the art. Thus, for example, the bar 2.17 may be cut or otherwise constructed as a one-piece, integral unit out of a metal capable of being permanently magnetized or the like, or may be cut and welded out of a first bar of permanently magnetized metal to form the magnetic portion 2.25 and a second bar of non-magnetic metal to form the non-magnetic portion 2.27, etc. The bar 2.17 may be constructed in various specific designs and sizes to fit a range of typical uses. For example, the bar 2.17 may be manufactured to have an overall length of 21 inches (53.34 centimeters), an overall width of 3 inches (7.62 centimeters), and a thickness of 0.25 inch (0.635 centimeters), with smooth, rounded edges, etc. The magnetic portion 2.25 of the bar 2.17 can be “permanently magnetized” in any manner now apparent to those skilled in the art such as, for example, by applying a magnetizing field from a stronger permanent magnet thereto, or by producing a magnetizing field by passing a large current through a coil.

A third preferred embodiment of the tool and part holder of the present invention is shown in FIGS. 11-15A, and identified by the numeral 3.11. The holder 3.11 is especially designed to be hung from support structure 3.13 (see FIG. 15A) such as, for example, part of the chassis of an automobile or the like being worked on, etc., and to hold various tools and miscellaneous parts 3.15 (see FIG. 15A) such as, for example, hammers, wrenches, screwdrivers, nuts, bolts, screws, nails, etc.

The holder 3.11 is similar in basic construction to the holder 11, and includes an elongated bar 3.17 having a first, or proximal, end 3.19 and a second, or distal, end 3.21. The bar 3.17 has a top or main support hook 3.23 at the first end 3.19 thereof for preferably being hooked over the support structure 3.13 as shown in FIG. 15A. The bar 3.17 has a magnetic portion 3.25 at the second end 3.21 thereof for allowing certain tools and miscellaneous parts 3.15 to be attached thereto by magnetic force (e.g., tools and parts made at least partially of a ferrous metal or the like). The bar 3.17 has a nonmagnetic portion 3.27 at the first end 3.19 thereof so that at least the first end 3.19 of the bar 3.17 can be supported from the support structure 3.13 without being magnetically attracted thereto. More than one half of the overall length of the bar 3.17 is preferably magnetic. More specifically, the ratio between the magnetic and non-magnetic portions 3.25, 3.27 is preferably 75 to 25, with 75% of the length of the bar 3.17 from the second end 3.21 preferably being magnetic and with 25% of the length of the bar 3.17 from the first end 3.19 preferably being non-magnetic.

The bar 3.17 preferably has a plurality of different sized apertures 3.29 extending therethrough for additional convenience in attaching non-magnetized objects to the holder 3.11. Thus, as clearly shown in FIG. 11, the bar 3.17 may have four apertures 3.29 extending therethrough ranging in size between, for example, 1 inch (2.54 centimeters), 3/4 inch (1.905 centimeters), 1/2 inch (1.27 centimeters), and 1/4 inch (0.635 centimeters).

The bar 3.17 may have at least one and preferably two bottom hooks 3.31 at the second end 3.21 thereof for allowing non-magnetically attractable tools, small parts, etc., to be hung therefrom, or to allow the holder 3.11 to be hung from the support structure 3.13 from the second end 3.21 of the bar 3.17. When two hooks 3.31 are included, the hooks 3.31 preferably oppose one another (i.e., with the open or distal end of each hook 3.31 arranged toward the midline of the bar 3.17 as clearly shown in FIG. 11). The bar 3.17 may have at least one and preferably two hooks 3.33 between the first and second ends 3.19, 3.21 thereof for allowing non-magnetically attractable or antimagnetic tools, small parts, etc., to be hung therefrom. The bottom end of each hook 3.33 preferably forms an enlarged, keyhole portion 3.34.

The bar 3.17 may be constructed in various manners, out of various materials as will now be apparent to those skilled in the art. Thus, for example, the bar 3.17 may be cut or otherwise constructed as a one-piece, integral unit out of a metal capable of being permanently magnetized or the like, or may be cut and welded out of a first bar of permanently magnetized metal to form the magnetic portion 3.25 and a second bar of non-magnetic metal to form the non-magnetic portion 3.27, etc. The bar 3.17 may be constructed in various specific designs and sizes to fit a range of typical uses. For example, the bar 3.17 may be manufactured to have an overall length of 21 inches (53.34 centimeters), an overall width of 3 inches (7.62 centimeters), and a thickness of 0.25 inch (0.635 centimeters), with smooth, rounded edges, etc. The magnetic portion 3.25 of the bar 3.17 can be “permanently magnetized” in any manner now apparent to those skilled in the art such as, for example, by applying a magnetizing field from a stronger permanent magnet thereto, or by producing a magnetizing field by passing a large current through a coil.

The holder 3.11 may include a spring catch 3.35 for closing the hook 3.23 at the first end 3.19 of the bar 3.17. The spring catch 3.35 is preferably substantially similar to a typical carabiner-type catch used in mountain climbing and the like, with the catch 3.35 being urged to an open position by the support structure 3.13 when the hook 3.23 is being moved over the support structure 3.13, and with the catch 3.35 being urged back to a closed position by an internal spring or the like after the support structure 3.13 is moved into the bight portion of the hook 3.23 as clearly shown in FIG. 15A to thereby lock the bar 3.17 onto the support structure 3.13 until the user of the bar 3.17 manually moves the catch 3.35 back to the open position to allow the hook 3.23 to be moved off the support structure 3.13 as will now be apparent to those skilled in the art.

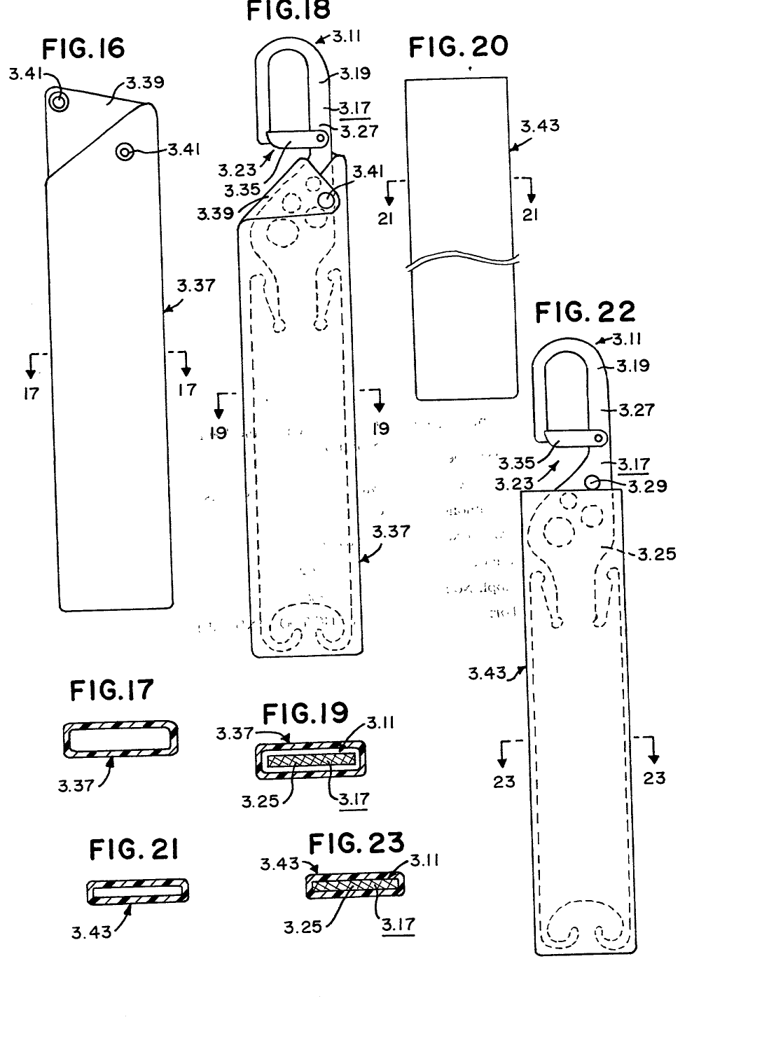

The holder 3.11 may include a non-magnetic sheath for covering the magnetized portion 3.25 of the bar 3.17 to prevent or hinder magnetic items from being attracted to the magnetized portion 3.25 of the bar 3.17 when the holder 3.11 is not in use. A first embodiment of the sheath is shown in FIGS. 16-19 and identified by the numeral 3.37. The sheath 3.37 extends from the second end 3.21 of the bar 3.17 to the hook 3.23 at the first end 3.19 of the bar 3.17. The sheath 3.37 preferably includes a flap 3.39 for folding over a neck portion of the first end 3.19 of the bar 3.17 directly below the hook 3.23, and a snap 3.41 for allowing the flap 3.39 to be “snapped” shut, thereby securing the sheath 3.37 to the bar 3.17. A second embodiment of the sheath is shown in FIGS. 20-23 and identified by the numeral 3.43. The sheath 3.43 extends from the second end 3.21 of the bar 3.17 to the junction between the magnetic and non-magnetic portions 3.25, 3.27 of the bar 3.17 to just cover the magnetic portion 3.25. The sheath 3.43 is preferably sized so as to fit over the second end 3.21 of the bar 3.17 in a relatively tight manner so that friction will secure the sheath 3.43 to the bar 3.17. Each of the sheaths 3.37, 3.43 may be molded or otherwise constructed out of plastic or other non-magnetic material so as to “block” the magnetic force of the magnetic portion 3.25 of the bar 3.17 to prevent tools, parts, etc., from being attracted thereto when not desired (e.g., when the holder 3.11 is stored in a toolbox or the like). It should be noted that holders 11, 2.11 may include similar sheaths.

Although the present invention has been described and illustrated with respect to preferred embodiments and preferred uses therefor, it is not to be so limited since modifications and changes can be made therein which are within the full intended scope of the invention.

1. A tool and part holder for holding various tools and miscellaneous parts, said holder comprising: an elongated bar having a first end and a second end; said bar having a hook at said first end thereof; said bar having a magnetic portion at said second end thereof; said bar having a non-magnetic portion at said first end thereof.

2. The holder of claim 1 in which said bar has a plurality of different sized apertures extending therethrough.

3. The holder of claim 2 in which said bar has a hook at said second end thereof.

4. The holder of claim 2 in which said bar has two hooks at said second end thereof.

5. The holder of claim 2 in which is included a non-magnetic sheath for covering said magnetized portion of said bar.

6. The holder of claim 5 in which said n on-magnetic sheath extends from said second end of said bar to said hook at said first end of said bar.

7. The holder of claim 1 which said magnetic portion of said bar extends 75 per cent of the length of said bar from said second end thereof.

8. The holder of claim 7 in which is included a non-magnetic sheath for covering said magnetized portion of said elongated body.

9. The holder of claim 1 in which said bar has a hook between said first and second ends thereof.

10. The holder of claim 1 in which said bar has two hooks between said first and second ends thereof.

11. The holder of claim 1 in which is included a spring catch for closing said hook at said first end of said bar.

12. A tool and part holder for holding various tools and miscellaneous parts, said holder comprising:
(a) an elongated bar having a first end and a second end; said bar having a hook at said first end thereof; said bar having a magnetic portion at said second end thereof; said bar having a non-magnetic portion at said first end thereof; said bar having a plurality of different sized apertures extending therethrough;
(b) a spring catch for closing said hook at said first end of said bar; and
(c) a non-magnetic sheath for covering said magnetized portion of said bar.

13. The holder of claim 12 in which said non-magnetic sheath extends from said second end of said bar to said hook at said first end of said bar.

14. The holder of claim 12 which said magnetic portion of said bar extends 75 per cent of the length of said bar from said second end thereof.

15. The holder of claim 12 in which said bar has a hook between said first and second ends thereof.

16. The holder of claim 15 in which said hook between said first and second ends of said bar has a bottom end forming an enlarged, keyhole portion.

17. The holder of claim 12 in which said bar has two hooks between said first and second ends thereof.

18. The holder of claim 17 in which each of said hooks between said first and second ends of said bar has a bottom end forming an enlarged, keyhole portion.

19. The holder of claim 12 in which said bar has two hooks at said second end thereof.

20. The holder of claim 19 in which said two hooks at said second end of said bar oppose one another.
